(19) United States
(12) Patent Application Publication
(10) Pub. No.: US 2021/0042702 A1
(43) Pub. Date: Feb. 11, 2021

(54) ORDER DELIVERY PROCESSING

(71) Applicant: BEIJING SANKUAI ONLINE TECHNOLOGY CO., LTD, Beijing (CN)

(72) Inventors: Xi CHEN, Beijing (CN); Zhengang GUO, Beijing (CN); Yabing QIN, Beijing (CN); Yu HU, Beijing (CN); Jianfeng SHI, Beijing (CN)

(21) Appl. No.: 16/968,570

(22) PCT Filed: Dec. 17, 2018
(86) PCT No.: PCT/CN2018/121601

§ 371 Date: Aug. 8, 2020

(30) Foreign Application Priority Data
Feb. 9, 2018 (CN) 201810136226.2

(51) Int. Cl. G06Q 10/08; G06Q 10/06; G06Q 30/06; G06Q 30/02

(52) U.S. Cl. CPC G06Q 10/08355; G06Q 10/08345; G06Q 30/0205; G06Q 30/0635; G06Q 30/0625; G06Q 10/06315

(57) ABSTRACT

An order delivery processing method includes: extracting target location information and merchant location information from a received order; determining whether the order is in a preset delivery range according to the target location information and the merchant location information; delivering the order based on a first preset rule when the order is not in the preset delivery range; sending first order-taking notification information to a merchant in response to receiving an order-taking operation of a deliverer in the target deliverer set; determining the order is effective in response to receiving an order-taking operation fed back by the merchant in response to the first order-taking notification information; and delivering the order based on a second preset rule when the order is in the preset delivery range.

### CROSS-REFERENCE TO RELATED APPLICATIONS

This application is the United States National Phase of PCT international application PCT/CN2018/121601, and this PCT international application claims priority to Chinese Patent Application No. 201810136226.2, filed on Feb. 9, 2018 and entitled “ORDER DELIVERY PROCESSING METHOD AND APPARATUS.” Both of the applications are incorporated herein by reference in its entirety.

### TECHNICAL FIELD

Embodiments of the present disclosure relate to an order delivery processing method and apparatus.

### BACKGROUND

In the case of delivering an instantly deliverable order, a delivery distance greatly affects smooth completion of the instantly deliverable order. When the delivery distance is short, both an order taking time and an effective time are short. When the delivery distance is long, both the order taking time and the effective time are long. As can be seen, an order fill rate of long-distance instantly deliverable orders is low.

### SUMMARY

A plurality of embodiments of the present disclosure provide an order delivery processing method. The method includes:
extracting target location information and merchant location information from a received order;
determining, according to the target location information and the merchant location information, whether the order is in a preset delivery range;
delivering the order based on a first preset rule when the order is not in the preset delivery range, where the delivering the order based on a first preset rule includes:
   determining a target deliverer set according to the target location information and the merchant location information;
   displaying the order to deliverers in the target deliverer set;
   sending first order-taking notification information to a merchant in response to receiving an order-taking operation of a deliverer in the target deliverer set; and
   determining an effective state of the order in response to receiving an order-taking operation fed back by the merchant in response to the first order-taking notification information; and delivering the order based on a second preset rule when the order is in the preset delivery range.

The plurality of embodiments of the present disclosure provide an electronic device, including: a processor, a memory, and a computer program stored in the memory. When executing the program, the processor implements the foregoing order delivery processing method.

The plurality of embodiments of the present disclosure provide a readable storage medium. When an instruction stored in the storage medium is executed by a processor of an electronic device, the electronic device is enabled to implement the foregoing order delivery processing method.

### BRIEF DESCRIPTION OF THE DRAWINGS

To describe the technical solutions in the embodiments of the present disclosure more clearly, the following briefly introduces the accompanying drawings required for describing the embodiments of the present disclosure. Apparently, the accompanying drawings in the following description show merely some embodiments of the present disclosure, and a person of ordinary skill in the art may still derive other drawings from these accompanying drawings without creative efforts.

FIG. 1 is a flowchart of steps of an order delivery processing method according to an embodiment of the present disclosure;

FIG. 2 is a flowchart of steps of an order delivery processing method according to an embodiment of the present disclosure;

FIG. 3 is a schematic diagram of a three-layer structure of delivery information according to an embodiment of the present disclosure;

FIG. 4 is a schematic diagram of an interface for setting a delivery mode and an effective range according to an embodiment of the present disclosure;

FIG. 5 is a schematic diagram of an interface for setting an effective time of a delivery mode according to an embodiment of the present disclosure;

FIG. 6 is a flowchart of steps of an order delivery processing method according to an embodiment of the present disclosure;

FIG. 7 is a flowchart of steps of an order delivery processing method according to an embodiment of the present disclosure;

FIG. 8 is a schematic structural diagram of an order delivery processing apparatus according to an embodiment of the present disclosure;

FIG. 9 is a schematic structural diagram of an order delivery processing apparatus according to an embodiment of the present disclosure;

FIG. 10 is a schematic structural diagram of an order delivery processing apparatus according to an embodiment of the present disclosure; and

FIG. 11 is a schematic structural diagram of an order delivery processing apparatus according to an embodiment of the present disclosure.

### DETAILED DESCRIPTION

The following clearly and completely describes the technical solutions in the embodiments of the present disclosure with reference to the accompanying drawings in the embodiments of the present disclosure. Apparently, the described embodiments are merely some but not all of the embodiments of the present disclosure. All other embodiments obtained by a person of ordinary skill in the art based on the embodiments of the present disclosure without creative efforts shall fall within the protection scope of the present disclosure.

To increase an order fill rate of long-distance instantly deliverable orders, in the prior art, a platform is staffed with more specialist deliverers to expand an effective range of specialist deliverers on the platform. However, costs such as training and management costs for the specialist deliverers on the platform are high. Alternatively, a crowdsourced deliverers are recruited to complete long-distance instantly deliverable orders. A user may input identity information and other verification information on an application platform to register as a crowdsourced deliverer, so as to receive order delivery tasks through the application platform. However, crowdsourced deliverers are less reliable, resulting in a low order-taking rate and poor user experience. In addition, orders that offer a low delivery fee and issued by a distant merchant are often not desired by crowdsourced deliverers.

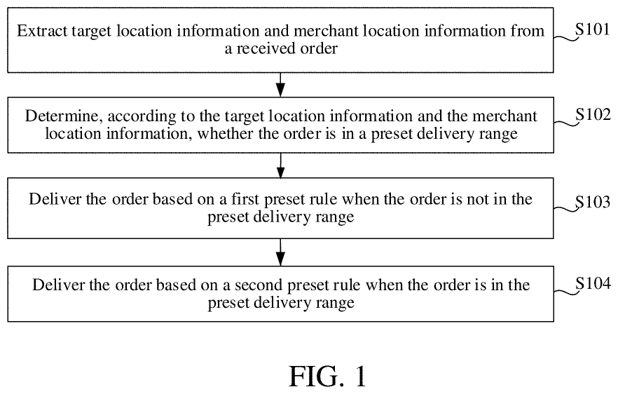

Refer to FIG. 1, which is a flowchart of steps of an order delivery processing method according to an embodiment of the present disclosure.

Step S101: Extract target location information and merchant location information from a received order.

The order is an instant order, that is, an order that is immediately deliverable after being placed by a user. Under normal circumstances, orders are placed in a local city. In practical applications, food delivery orders are the most common instant orders. When a large number of users generate a large number of orders, all orders will enter an order pool. A system obtains orders in a chronological sequence of placing the orders, and processes the orders.

The target location information corresponds to location information of an order destination. By default, the current location information of the user is obtained through a positioning system, and is used as the target location information. The user may also modify the target location information to another location.

The merchant location information is input into the platform when the merchant is registered and domiciled at the application platform, and is saved in a database of the platform system. Therefore, in placing an order, the corresponding merchant location information can be obtained from the database according to a merchant identifier.

The embodiment of the present disclosure is applicable to local delivery scenarios such as instant delivery and shopping in which the orders are placed on a designated application platform.

Step S102: Determine, according to the target location information and the merchant location information, whether the order is in a preset delivery range.

In some embodiments of the present disclosure, the preset delivery range is a short-distance delivery range, and may be set according to actual application scenarios.

For example, in practical applications, when the preset delivery range is set to a range within 3 kilometers around the merchant, a distance between a target location and a merchant location is calculated; then, it is determined whether the target location is within 3 kilometers around the merchant; when the target location is within this range, the order is in the preset delivery range; when the target location is not within this range, the order is not in the preset delivery range.

Step S103: Deliver the order based on a first preset rule when the order is not in the preset delivery range. The delivering the order based on a first preset rule includes: determining a target deliverer set according to the target location information and the merchant location information, and displaying the order to deliverers in the target deliverer set; sending order-taking notification information to a merchant in response to receiving an order-taking operation of a deliverer in the target deliverer set; and determining that the order is effective in response to receiving an order-taking operation fed back by the merchant in response to the order-taking notification information.

The embodiment of the present disclosure applies different order-taking sequences to orders placed at different distances. For an order placed at a medium or long distance, the order-taking sequence lets deliverers seize the order first before the merchant takes the order, thereby ensuring an order-taking success rate of the orders placed at medium and long distances and improving user experience.

Step S104: Deliver the order based on a second preset rule when the order is in the preset delivery range.

In some embodiments of the present disclosure, first, the merchant corresponding to the order is instructed to take the order. Then, after the merchant takes the order, a deliverer is determined according to a preset delivery mode and is instructed to take the order. Finally, after the deliverer takes the order, the order takes effect, and the deliverer delivers the order to the target location.

In conclusion, the embodiment of the present disclosure provides an order delivery processing method. The method includes: obtaining an order, where the order includes target location information and merchant location information; determining, according to the target location information and the merchant location information, whether the order is in a preset delivery range; delivering the order based on a first preset rule when the order is not in the preset delivery range, the first preset rule includes: determining a target deliverer set according to the target location information and the merchant location information, and displaying the order to deliverers in the target deliverer set; sending order-taking notification information to a merchant in response to receiving an order-taking operation of a deliverer in the target deliverer set; determining that the order is effective in response to receiving an order-taking operation fed back by the merchant in response to the order-taking notification information; and delivering the order based on a second preset rule when the order is in the preset delivery range. The mode in which the deliverer seizes the order first before the merchant takes the order improves the order-taking rate and user experience of orders placed at medium and long distances.

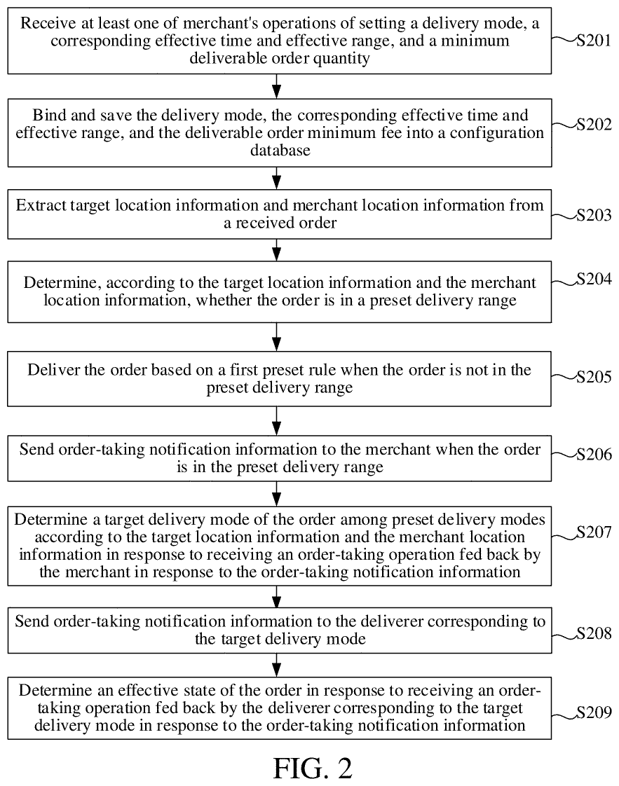

FIG. 2 shows a flowchart of steps of an order delivery processing method according to an embodiment of the present disclosure.

Step S201: Receive at least one of merchant's operations of setting a delivery mode, a corresponding effective time and effective range, and a minimum deliverable order quantity.

In some embodiments of the present disclosure, the delivery mode includes but is not limited to platform specialist delivery, merchant self-delivery, and a platform errand.

The platform specialist delivery means delivery made by a deliverer who has signed a labor contract with the application platform. The deliverers are employees of the application platform, and are trained, uniformly managed and the like by the platform.

The merchant self-delivery means delivery made by the merchant's own deliverer.

The platform errand means delivery made by a crowdsourced deliverer. In actual applications, a user may become a crowdsourced deliverer by logging in to the application platform and registering and verifying relevant information.

Understandably, without requiring training, uniform management, or the like, a crowdsourced deliverer is cost-effective but less reliable, while the platform specialist deliverer and the merchant's own deliverer are relatively costly but more reliable.

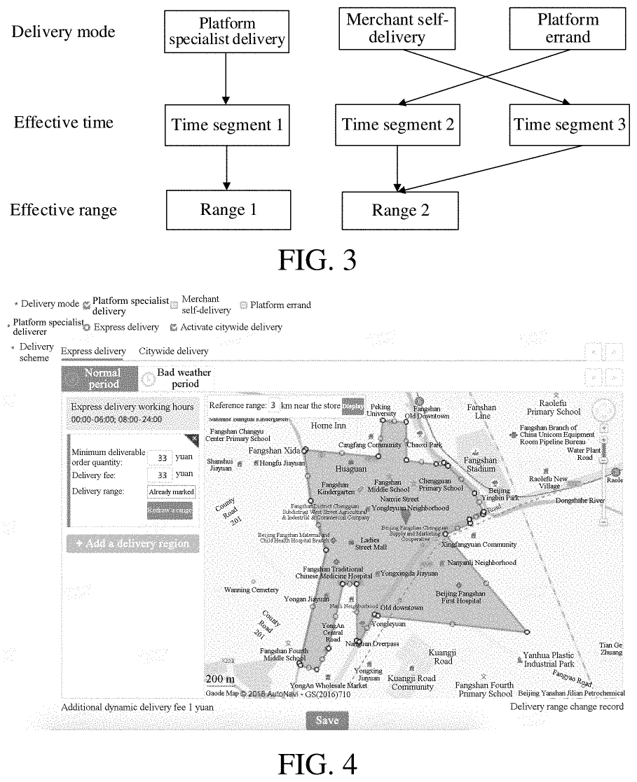

In some embodiments of the present disclosure, a three-layer structure is applied to set the delivery mode. As shown in FIG. 3, a first layer is the delivery mode, a second layer is the effective time, and a third layer is the effective range. The drawing shows three types of delivery information: platform specialist delivery—time segment 1—range 1, merchant self-delivery—time segment 3—range 2, and platform errand—time segment 2—range 2. Understandably, the delivery mode, the effective time, and the effective range may be arbitrarily combined.

In practical applications, when getting registered and domiciled at the application platform, the merchant may set a delivery mode. On a setting interface shown in FIG. 4, the set delivery mode is platform specialist delivery.

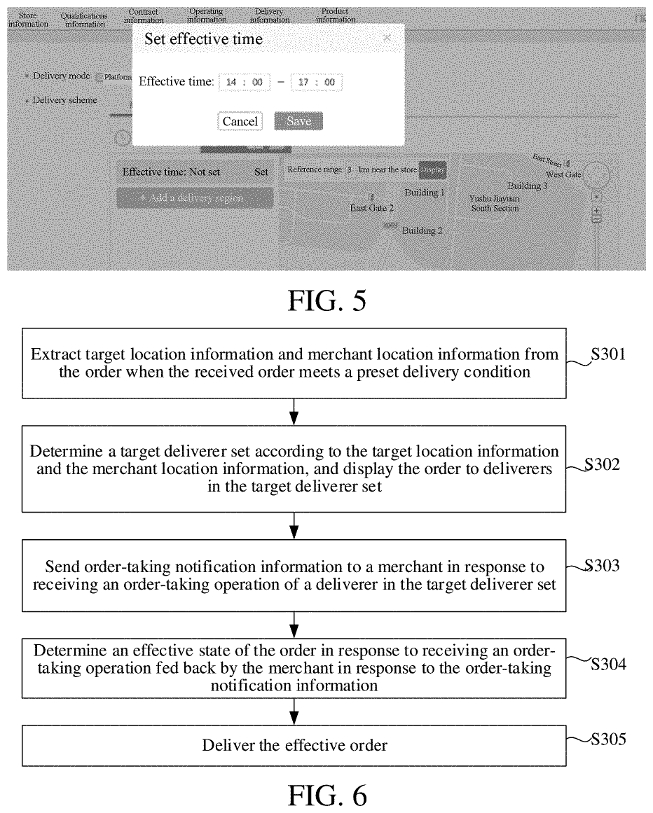

When the user chooses to set an effective time for platform specialist delivery, the interface shown in FIG. 5 appears. The user may input a start time and an end time. An obtained effective time segment of the platform specialist delivery is between a start time point and an end time point. For example, as shown in FIG. 5, the start time point is 14:00, and the end time point is 17:00. Therefore, the merchant supports platform specialist delivery between 14:00 and 17:00, and does not support platform specialist delivery in other time segments.

As shown in FIG. 4, when the user clicks “Add delivery region” on the left, an effective range corresponding to platform specialist delivery may be added on the right side of the map interface, so that platform specialist delivery is supported in such a range, and the platform specialist delivery is not supported outside such a range.

In conclusion, an order is delivered in a delivery mode only when the order is placed within the effective time of the delivery mode and only when a delivery target location is within the effective range of the delivery mode.

In some embodiments of the present disclosure, a deliverable order minimum fee may be set for the delivery mode while setting the delivery mode. In this way, a different deliverable order minimum fee may be set for each different merchant and each different delivery mode. The deliverable order minimum fee is a minimum fee paid for the order. Delivery is supported only when the deliverable order fee of the user is greater than or equal to the deliverable order minimum fee. Otherwise, delivery is not supported.

For example, for merchant's self-delivery, the set effective time is in the morning, the set effective range is relatively small, and the set deliverable order minimum fee is relatively high. For platform specialist delivery, the set effective time is from the morning to the afternoon, the set effective range is relatively wide, and the set deliverable order minimum fee is relatively low; for platform errands, the set effective time is at night, the set effective range is relatively wide, and the set deliverable order minimum fee is relatively high. In this way, the delivery mode is set flexibly to increase delivery speeds and reduce delivery disputes.

Step S202: Bind and save the delivery mode, the corresponding effective time and effective range, and the deliverable order minimum fee into a configuration database.

Understandably, the delivery mode, the effective time, the effective range, and the deliverable order quantity minimum fee correspond to one another, and need to be stored according to a correspondence relationship.

In some embodiments of the present disclosure, the delivery mode, the effective time, the effective range, and the deliverable order minimum fee are saved as delivery mode information of a merchant. In this way, in placing an order with the merchant, the corresponding delivery mode information can be obtained according to a merchant identifier.

Step S203: Extract target location information and merchant location information from a received order.

For this step, reference may be made to the description of step S101, and details are omitted here.

Step S204: Determine, according to the target location information and the merchant location information, whether the order is in a preset delivery range.

For this step, reference may be made to the description of step S102, and details are omitted here.

Step S205: Deliver the order based on a first preset rule when the order is not in the preset delivery range. The delivering the order based on a first preset rule includes: determining a target deliverer set according to the target location information and the merchant location information, and displaying the order to deliverers in the target deliverer set; sending order-taking notification information to a merchant in response to receiving an order-taking operation of a deliverer in the target deliverer set; and determining that the order is effective in response to receiving an order-taking operation fed back by the merchant in response to the order-taking notification information.

For this step, reference may be made to the description of step S103, and details are omitted here.

Step S206: Send order-taking notification information to the merchant when the order is in the preset delivery range.

In some embodiments of the present disclosure, the order-taking notification information includes but is not limited to: order number, order placing time, order details, and target location.

Orders are numbered in different ways depending on the merchant.

The order placing time corresponds to a system time when the user submits the order, and may be obtained according to the system time that is determined via a function.

The order details correspond to a product list displayed when the user places the order with the merchant, and may include one or more products. For example, for a food delivery order, the order details include types and quantity of dishes.

For the target location, reference may be made to the description of step S101, and details are omitted here.

Understandably, the format and content of the order-taking notification information may be set depending on the actual application scenario, which is not limited in the embodiment of the present disclosure.

For a short-distance order, the embodiment of the present disclosure allows the merchant to be instructed to take the order first, and allows the deliverer to take the order after the merchant takes the order.

Step S207: Determine a target delivery mode of the order among preset delivery modes according to the target location information and the merchant location information in response to receiving an order-taking operation fed back by the merchant in response to the order-taking notification information.

Understandably, the order-taking operation is confirmation information for confirming the order-taking notification information. In practical applications, the merchant may reject the order by sending an order rejection operation, or may refrain from performing an order-taking operation.

For example, the preset delivery mode is the delivery mode that is set in steps S201 to S202.

In some embodiments of the present disclosure, the delivery mode includes an effective time and an effective range, and step S207 includes substeps S2071 to S2073:

Substep S2071: Extract the order placing time from the order.

For example, the order placing time corresponds to a time point when the user submits the order.

Substep S2072: Obtain, from a preset configuration database, at least one delivery mode corresponding to the merchant and an effective time and an effective range that correspond to each delivery mode.

As can be seen from the description of step S202, the configuration database stores the merchant's delivery mode information, including a delivery mode, a corresponding effective time and effective range, and a deliverable order minimum fee.

For example, the delivery mode of the merchant and the corresponding effective time and effective range may be obtained from the configuration database according to the merchant identifier.

Understandably, for a merchant, two or more delivery modes may be set at the same time, and multiple delivery modes may be obtained. In this case, one delivery mode needs to be selected from the multiple delivery modes.

Substep S2073: Determine the target delivery mode among at least one delivery mode according to the order placing time, the target location information, the merchant location information, and the effective time and the effective range that correspond to the delivery mode.

For each delivery mode, it is determined whether the order placing time is within the effective time of the delivery mode. Based on the merchant location information, it is determined whether the target location is within the effective range of the delivery mode. When the order placing time is within the effective time of the delivery mode and the target location is within the effective range of the delivery mode, the delivery mode is the target delivery mode.

For example, the effective time corresponding to a delivery mode 1 is 08:00 to 13:00, and the corresponding effective range is 1 km around the merchant; the effective time corresponding to a delivery mode 2 is 13:00 to 18:00, and the corresponding effective range is 2 km around the merchant; and the effective time corresponding to a delivery mode 3 is 18:00 to 22:00, and the corresponding effective range is 3 km around the merchant. For an order, when the order placing time is 11:30 and the target location is 0.5 km around the merchant, the target delivery mode of the order is the delivery mode 1.

In some embodiments of the present disclosure, after substep S2073, substeps S2074 and S2075 are further included in the method.

Substep S2074: Obtain a minimum deliverable order quantity corresponding to each target delivery mode from the configuration database when at least two target delivery modes are determined.

In practical applications, the effective time and the effective range may overlap between different delivery modes. For example, the effective time corresponding to a delivery mode 1 is 08:00 to 13:00, and the corresponding effective range is 1 km around the merchant; the effective time corresponding to a delivery mode 2 is 11:00 to 18:00, and the corresponding effective range is 2 km around the merchant; and the effective time corresponding to a delivery mode 3 is 18:00 to 22:00, and the corresponding effective range is 3 km around the merchant. As can be seen, the effective times of the delivery mode 1 and the delivery mode 2 have an overlap of 11:00 to 13:00, and the delivery ranges of the delivery method 1, the delivery mode 2, and the delivery mode 3 have an overlap of 1 km around the merchant.

Therefore, when the order placing time and the target location of an order falls within an overlapping part of the effective time and the effective range of two delivery modes, at least two target delivery modes may be determined according to substep 2073.

For example, in a scenario in which the effective times of the delivery mode 1 and the delivery mode 2 overlap and the effective ranges of the delivery mode 1, the delivery mode 2, and the delivery mode 3 overlap, if the order placing time of an order is 12:00, the target location is 0.5 km near the merchant, the target delivery modes of the order correspond to the delivery mode 1 and the delivery mode 2.

Substep S2075: Select a final delivery mode from the at least two target delivery modes according to the deliverable order minimum fee.

In the foregoing scenario in which two or more target delivery modes exist, the delivery mode with a lower deliverable order minimum fee is selected as the final delivery mode. For example, when the delivery mode 1 and the delivery mode 2 correspond to the deliverable order minimum fee 20 yuan and 18 yuan respectively, the delivery mode 2 is selected as the final delivery mode.

In an embodiment, when an operation of submitting the order is received, step S207 includes substeps S2076 to S2078:

Substep S2076: Determine whether the target location information and the order placing time of the order have changed.

In practical applications, the user's entire ordering process may exceed end points of the effective time of the delivery mode. For example, when the user's order placing time is 17:55, but the time changes to 18:05 when the user submits the order, the delivery mode determined according to the order placing time 17:55 and the order submitting time 18:05 do not belong to the effective time of the same delivery mode, so that the delivery mode needs to be updated.

In addition, the user's location information may change. The user may keep moving while placing an order, or may modify the target location information when submitting the order.

In response to a received submitting operation, a current time of the system and a current location of the user or the target location information of the order are obtained; then, the current time is compared with the order placing time, and the current location is compared with the target location information in the order. If at least either the order placing time or the target location has changed, it is necessary to determine whether to change the delivery mode.

In practical applications, in response to that the user's operation of modifying the target location in the order is detected, it is also necessary to determine whether to change the delivery mode.

Substep S2077: Determine, according to the changed target location information and/or order placing time, whether to change the delivery mode, in response to that the target location information and/or order placing time of the order has changed.

For example, according to substep S2073, the delivery mode may be re-determined, and whether to change the delivery mode is determined.

In some embodiments of the present disclosure, substep S2077 includes substeps S20771 to S20773:

Substep S20771: Determine a target delivery mode among at least one delivery mode according to the original order placing time, the changed target location information, the merchant location information, and the effective time and the effective range that correspond to the delivery mode in response to that the target location information of the order has changed.

In this step, the target delivery mode is re-determined according to the changed target location.

Substep S20772: Determine a target delivery mode among at least one delivery mode according to the changed order placing time, the original target location information, the merchant location information, and the effective time and the effective range that correspond to the delivery mode in response to that the order placing time has changed.

In this step, the target delivery mode is re-determined according to the changed order placing time.

Substep S20773: Determine a target delivery mode among at least one delivery mode according to the changed order placing time, the changed target location information, the merchant location information, and the effective time and the effective range that correspond to the delivery mode in response to that the target location information and the order placing time of the order have changed.

In this step, the target delivery mode is re-determined according to the changed target location and the changed order placing time.

Substep S2078: Prompt a change of the delivery mode to the user in response to that the delivery mode has changed.

The delivery mode is compared with the original delivery mode. In response to that the delivery mode has changed, a prompt is sent to the user to indicate that the delivery mode has changed. If the delivery mode remains unchanged, no prompt is sent to the user, and the order is delivered in the original delivery mode.

Step S208: Send order-taking notification information to the deliverer corresponding to the target delivery mode.

For example, the order-taking notification information includes but is not limited to:

order number, order placing time, order details, target location, merchant name, and merchant location information.

The merchant name and the merchant location information help the deliverer obtain a product corresponding to the order.

For the order number, order placing time, order details, and target location, reference may be made to the description of step S206, and details are omitted here.

In some embodiments of the present disclosure, step S208 further includes substeps S2081 and S2082:

Substep S2081: Send order-taking notification information to the deliverer corresponding to the changed delivery mode in response to receiving an operation of confirming the change of the delivery mode.

When the user receives a request asking whether to change the delivery mode, the changed delivery mode is preferred.

Substep S2082: Send order-taking notification information to a deliverer corresponding to a before-change delivery mode in response to receiving an operation of ignoring change of the delivery mode.

In the embodiment of the present disclosure, when the delivery mode has changed, the user is recommended to select the updated delivery mode. When the user chooses to ignore the operation, the original delivery mode is used for delivery, so as to maximally ensure user experience and avoid delivery disputes.

In practical applications, when the user chooses to change the delivery mode, a prompt may be sent to the user to indicate that the order will be cancelled due to a delivery problem, and the order is cancelled after the user clicks OK.

Step S209: Determine an effective state of the order in response to receiving an order-taking operation fed back by the deliverer corresponding to the target delivery mode in response to the order-taking notification information.

The deliverer corresponding to the target delivery mode takes the order by seizing the order. The deliverer who seizes the order first will deliver the order.

In the embodiment of the present disclosure, the order-taking deliverer delivers the effective order.

Understandably, the order will take effect only when both the merchant and the deliverer take the order. The merchant or the deliverer may also cancel the order. The order becomes invalid as long as either the merchant or the deliverer cancels the order.

In conclusion, the embodiment of the present disclosure provides an order delivery processing method. The method includes: obtaining an order, where the order includes target location information and merchant location information; determining, according to the target location information and the merchant location information, whether the order is in a preset delivery range; delivering the order based on a first preset rule when the order is not in the preset delivery range, where the delivering the order based on a first preset rule includes: determining a target deliverer set according to the target location information and the merchant location information, and displaying the order to deliverers in the target deliverer set; sending order-taking notification information to a merchant in response to receiving an order-taking operation of a deliverer in the target deliverer set; determining an effective state of the order in response to receiving an order-taking operation fed back by the merchant in response to the order-taking notification information; and delivering the order based on a second preset rule when the order is in the preset delivery range. The mode in which the deliverer seizes the order first before the merchant takes the order improves the order-taking rate and user experience. In addition, the change of the delivery mode may be prompted to the user when the user submits the order, the delivery mode is flexibly configurable, and the delivery mode with a relatively low minimum deliverable order quantity can be selected first.

FIG. 6 shows a flowchart of steps of an order delivery processing method according to an embodiment of the present disclosure. The method includes the following steps.

Step S301: Extract target location information and merchant location information from the order when the received order meets a preset delivery condition.

The preset delivery condition is whether the merchant corresponding to the order supports orders placed at medium and long distances. When the merchant corresponding to the order supports orders placed at medium and long distances, the order meets the preset delivery condition. When the merchant corresponding to the order does not support orders placed at medium and long distances, the order does not meet the preset delivery condition.

For the target location information and the merchant location information, reference may be made to the description of step S101, and details are omitted here.

Step S302: Determine a target deliverer set according to the target location information and the merchant location information, and display the order to deliverers in the target deliverer set.

In the embodiment of the present disclosure, the deliverer may be determined according to a delivery distance between the target location and the merchant location.

In some embodiments of the present disclosure, orders placed at medium and long distances are delivered by crowdsourced deliverers. For a description of the crowdsourced deliverers, reference may be made to the description of step S201, and details are omitted here.

In practical applications, the deliverer logs into the platform using an account ID that identifies an identity, so that the platform displays the order to a specified type of deliverers according to the type of the deliverer. For example, for a crowdsourced deliverer, after the deliverer is registered, this type of deliverer will be added into a crowdsourced deliverer pool.

Step S303: Send order-taking notification information to a merchant in response to receiving an order-taking operation of a deliverer in the target deliverer set.

In practical applications, when an order is displayed to each deliverer in the target deliverer set, each deliverer may take the order by seizing. The deliverer who seizes the order first is the deliverer of the order.

In the embodiment of the present disclosure, the order-taking notification information may include deliverer information in addition to the information mentioned in step S206.

Step S304: Determine an effective state of the order in response to receiving an order-taking operation fed back by the merchant in response to the order-taking notification information.

In the embodiment of the present disclosure, the deliverer seizes the order first before the merchant takes the order. Therefore, the order takes effect after the merchant takes the order.

In practical applications, an effective order may be added into an effective order pool, so that the merchant can process orders in a sequence of placing the orders.

Understandably, effective orders are added into the effective order pool for each merchant separately.

Step S305: Deliver the effective order.

In some embodiments of the present disclosure, the order is delivered by the deliverer who initiates the order-taking operation in step S303.

In practical applications, the deliverer first picks up a product corresponding to the order from the merchant corresponding to the order. If the product is not ready, the deliverer needs to wait. Then, after the product is ready, the deliverer delivers the product to the target location corresponding to the order to complete the order delivery. Finally, the delivered order is settled, and the proceeds are allocated to the deliverer, the merchant, the platform, and the like.

In conclusion, the embodiment of the present disclosure provides an order delivery processing method. The method includes: extracting target location information and merchant location information from the order when the received order meets a preset delivery condition; determining a target deliverer set according to the target location information and the merchant location information, and displaying the order to deliverers in the target deliverer set; sending order-taking notification information to a merchant in response to receiving an order-taking operation of a deliverer in the target deliverer set; determining an effective state of the order in response to receiving an order-taking operation fed back by the merchant in response to the order-taking notification information; and delivering the effective order. In the order delivery processing method, a deliverer seizes an order first before a merchant takes the order, thereby improving an order-taking rate and user experience.

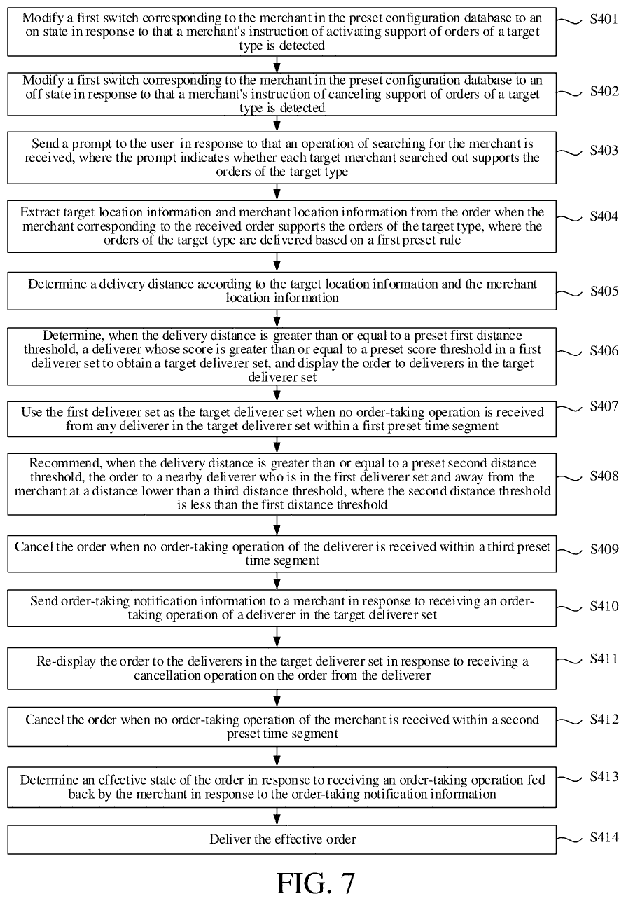

FIG. 7 shows a flowchart of steps of an order delivery processing method according to an embodiment of the present disclosure.

Step S401: Modify a first switch corresponding to the merchant in the configuration database to an on state in response to that a merchant's instruction of activating support of orders of a target type is detected.

The orders of the target type correspond to orders placed at medium and long distances.

The embodiment of the present disclosure can flexibly control whether the merchant supports orders placed at medium and long distances.

When registering on the application platform, the merchant sets, on a setting interface, whether to support orders placed at medium and long distances. In addition, in a subsequent use process, modification may be made again.

After the modification, the first switch of the corresponding merchant is modified according to the merchant identifier.

In practical applications, a switch state may be denoted by a string of characters. For example, “YES” indicates an on state, and “NO” indicates an off state. The switch state may also be denoted by an enumerated value. For example, “1” indicates an on state, and “0” indicates an off state. Understandably, the value of the switch state may be set depending on the actual application scenario, which is not limited in the embodiment of the present disclosure.

Step S402: Modify the first switch corresponding to the merchant in the configuration database to an off state in response to that a merchant's instruction of canceling support of the orders of the target type is detected.

When the first switch is turned off, the merchant does not support orders placed at medium and long distances.

Step S403: Send a prompt to the user in response to that an operation of searching for the merchant is received, where the prompt indicates whether each target merchant searched out supports the orders of the target type.

In practical applications, the user may input a search keyword in the search box, or select key information in a selection box. According to the search keyword and key information, the platform obtains, from the database, merchants that meet the condition.

In the embodiment of the present disclosure, a merchant profile in a search result list indicates whether the merchant supports orders placed at medium and long distances. This helps the user preliminarily determines whether to enter the merchant details interface to place an order. This also avoids failure of placing the order that is placed by the user at a too long distance, and improves user experience.

In the embodiment of the present disclosure, first, whether the first switch corresponding to the merchant is turned on is determined according to a configuration database. Then, when the first switch is turned on, a prompt is sent to the user indicating support of orders placed at medium and long distances; when the first switch is turned off, a prompt is sent to the user indicating no support of orders placed at medium and long distances.

Step S404: Extract target location information and merchant location information from the order when the merchant corresponding to the received order supports the orders of the target type, where the orders of the target type are delivered based on a first preset rule.

For the first preset rule, reference may be made to the detailed description of step S103.

In the embodiment of the present disclosure, the orders placed at medium and long distances are delivered based on the first preset rule. That is, the deliverer seizes the order first before the merchant takes the order.

Step S405: Determine a delivery distance according to the target location information and the merchant location information.

In some embodiments of the present disclosure, the delivery distance may be determined according to a target location and a merchant location on a map interface. In practical applications, the distance can be a straight-line distance or a road-based distance.

Step S406: Determine, when the delivery distance is greater than or equal to a preset first distance threshold, a deliverer whose score is greater than or equal to a preset score threshold in a first deliverer set to obtain a target deliverer set, and display the order to deliverers in the target deliverer set.

The first distance threshold is used to determine whether the order is an order placed at a long distance, and may be set according to an actual application scenario.

The score threshold is used to determine whether a score record of the deliverer is good, and may be set according to the actual application scenario. In the embodiment of the present disclosure, a deliverer with a good score record is selected to deliver the order, so as to ensure smooth delivery of the order.

In the embodiment of the present disclosure, the first deliverer set is a crowdsourced deliverer set.

In practical applications, after the deliverer completes delivering the order, the user and the merchant may score the deliverer. For example, a perfect score is five stars. Therefore, more stars indicate a higher score, and fewer stars indicate a lower score. If a perfect score is 100 points, more points indicate a higher score, and fewer points indicate a lower score.

Understandably, for different types of scoring rules, different scoring thresholds need to be set. For example, in scoring by stars, the scoring threshold may be 3 stars; in scoring by a percentage, the scoring threshold may be set to 70%, and the like.

Step S407: Use the first deliverer set as the target deliverer set when no order-taking operation is received from any deliverer in the target deliverer set within a first preset time segment.

The first preset time segment is used to determine whether a deliverer with a good score record takes the order, and may be set according to the actual application scenario.

In the embodiment of the present disclosure, when no deliverer with a good score record takes the order, the deliverer set for taking the order may be expanded, so that all crowdsourced deliverers can seize the order, thereby increasing the order-taking rate.

Step S408: Recommend, when the delivery distance is greater than or equal to a preset second distance threshold, the order to a deliverer who is in the first deliverer set and away from the merchant at a distance lower than a third distance threshold, where the second distance threshold is less than the first distance threshold.

In some embodiments of the present disclosure, the second distance threshold is used to determine whether the order is an order placed at a medium distance, and may be set according to an actual application scenario.

In the embodiment of the present disclosure, when no crowdsourced deliverer takes the order, the order may be recommended to a crowdsourced deliverer near the merchant, thereby increasing the order-taking rate.

In some embodiments of the present disclosure, first, a crowdsourced deliverer near the merchant is obtained through a positioning system. Then, the order is pushed to a terminal corresponding to the crowdsourced deliverer. When a screen of the terminal is off, a prompt tone is raised to give a prompt, and the order is displayed on a notification interface. When the screen of the terminal is on but the application platform runs at a background, the order is displayed on the notification interface. When the screen of the terminal is on and the application platform runs at a current interface, the order is displayed in a designated location on the platform interface.

Step S409: Cancel the order when no order-taking operation of the deliverer is received within a third preset time segment.

In some embodiments of the present disclosure, the third preset time segment is used to determine whether any crowdsourced deliverer takes the order. Understandably, the third preset time segment is greater than the first preset time segment. Understandably, the third preset time segment may be set according to the actual application scenario. For example, in a peak order period, the third preset time segment may be set to a larger value; in a trough order period, the third preset time segment may be set to a smaller value.

In practical applications, the order is cancelled when no crowdsourced deliverer takes the order within the third preset time segment after steps S406 to S408.

Step S410: Send order-taking notification information to a merchant in response to receiving an order-taking operation of a deliverer in the target deliverer set.

For this step, reference may be made to the description of step S303, and details are omitted here.

Step S411: Re-display the order to the deliverers in the target deliverer set in response to receiving a cancellation operation on the order from the deliverer.

Understandably, the cancellation operation on the order by the deliverer may be performed before the merchant takes the order or after the merchant takes the order.

In the embodiment of the present disclosure, the cancelled order may be re-displayed to the crowdsourced deliverer, thereby increasing the order-taking success rate.

Step S412: Cancel the order when no order-taking operation of the merchant is received within a second preset time segment.

In some embodiments of the present disclosure, the second preset time segment is used to determine whether a merchant takes the order after the deliverer takes the order, and may be set according to the actual application scenario.

In practical applications, in a peak order period, because the merchant has more orders and offers a lower processing speed, a larger second preset time segment may be set to wait for the merchant to take the order, so as to increase the order-taking rate. In a period with small amount of orders, a smaller second preset time segment may be set because the merchant has fewer orders and offers a higher processing speed.

Step S413: Determine an effective state of the order in response to receiving an order-taking operation fed back by the merchant in response to the order-taking notification information.

For this step, reference may be made to the description of step S304, and details are omitted here.

Step S414: Deliver the effective order.

For this step, reference may be made to the description of step S305, and details are omitted here.

In conclusion, the embodiment of the present disclosure provides an order delivery processing method. The method includes: extracting target location information and merchant location information from the order when the received order meets a preset delivery condition; determining a target deliverer set according to the target location information and the merchant location information, and displaying the order to deliverers in the target deliverer set; sending order-taking notification information to a merchant in response to receiving an order-taking operation of a deliverer in the target deliverer set; determining an effective state of the order in response to receiving an order-taking operation fed back by the merchant in response to the order-taking notification information; and delivering the effective order. In the order delivery processing method, a deliverer seizes an order first before a merchant takes the order, thereby improving an order-taking rate and user experience. In addition, priority may be given to excellent crowdsourced deliverers to deliver the order. When no excellent crowdsourced deliverer is available to take the order, the order is recommended to the crowdsourced deliverer near the merchant. After the deliverer cancels the order, the order is returned to an order-seizing pool for being seized again. Before the order is placed, a prompt is sent to the user to ask whether the delivery of orders placed at medium and long distances is supported, thereby further improving user experience.

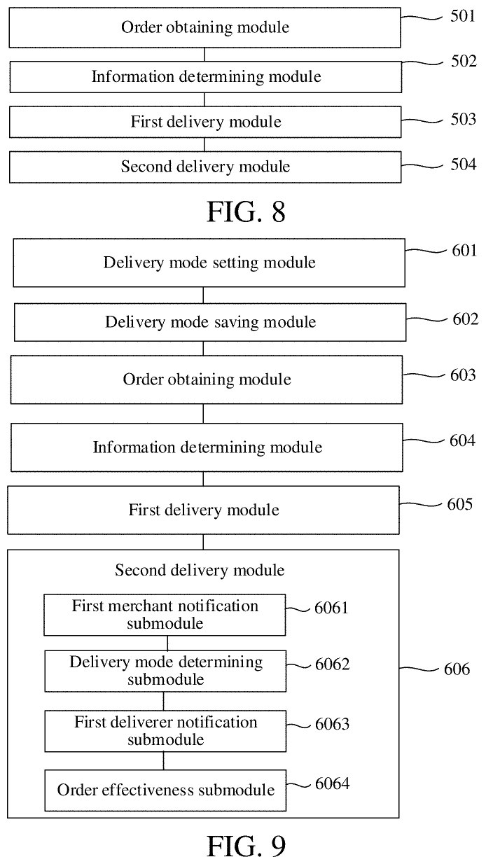

Refer to FIG. 8, which shows a structural diagram of an order delivery processing apparatus according to an embodiment of the present disclosure, the order delivery processing apparatus includes:

an order obtaining module 501, configured to extract target location information and merchant location information from a received order;

an information determining module 502, configured to determine, according to the target location information and the merchant location information, whether the order is in a preset delivery range;

a first delivery module 503, configured to: deliver the order based on a first preset rule when the order is not in the preset delivery range, where the delivering the order based on a first preset rule includes: determining a target deliverer set according to the target location information and the merchant location information, and displaying the order to deliverers in the target deliverer set; sending order-taking notification information to a merchant in response to receiving an order-taking operation of a deliverer in the target deliverer set; and determining an effective state of the order in response to receiving an order-taking operation fed back by the merchant in response to the order-taking notification information; and

a second delivery module 504, configured to deliver the order based on a second preset rule when the order is in the preset delivery range.

Refer to FIG. 9, which shows a structural diagram of an order delivery processing apparatus according to an embodiment of the present disclosure, the order delivery processing apparatus includes:

a delivery mode setting module 601, configured to receive, from a merchant, an operation of setting a delivery mode, an effective time and an effective range that correspond to the delivery mode, and a deliverable order minimum fee;

a delivery mode saving module 602, configured to bind and save the delivery mode, the corresponding effective time and effective range, and the deliverable order minimum fee into a configuration database;

an order obtaining module 603, configured to extract target location information and merchant location information from a received order;

an information determining module 604, configured to determine, according to the target location information and the merchant location information, whether the order is in a preset delivery range;

a first delivery module 605, configured to: deliver the order based on a first preset rule when the order is not in the preset delivery range, where the delivering the order based on a first preset rule includes: determining a target deliverer set according to the target location information and the merchant location information, and displaying the order to deliverers in the target deliverer set; sending order-taking notification information to the merchant in response to receiving an order-taking operation of a deliverer in the target deliverer set; and determining an effective state of the order in response to receiving an order-taking operation fed back by the merchant in response to the order-taking notification information; and

a second delivery module 606, configured to deliver the order based on a second preset rule when the order is in the preset delivery range. In some embodiments of the present disclosure, the second delivery module 606 includes:

a first merchant notification submodule 6061, configured to send order-taking notification information to the merchant when the order is in the preset delivery range;

a delivery mode determining submodule 6062, configured to determine a target delivery mode of the order among preset delivery modes according to the target location information and the merchant location information when receiving an order-taking operation fed back by the merchant in response to the order-taking notification information;

a first deliverer notification submodule 6063, configured to send order-taking notification information to the deliverer corresponding to the target delivery mode; and

an order effectiveness submodule 6064, configured to determine an effective state of the order in response to receiving an order-taking operation fed back by the deliverer corresponding to the target delivery mode in response to the order-taking notification information.

In some embodiments of the present disclosure, the delivery mode includes an effective time and an effective range, and the delivery mode determining submodule 6062 includes:

an order placing time extraction unit, configured to extract an order placing time from the order;

a delivery mode obtaining unit, configured to obtain, from a preset configuration database, at least one delivery mode corresponding to the merchant and an effective time and an effective range that correspond to each delivery mode; and

a delivery mode determining unit, configured to determine a target delivery mode among at least one delivery mode according to the order placing time, the target location information, the merchant location information, and the effective time and the effective range that correspond to the delivery mode.

In some embodiments of the present disclosure, the delivery mode determining submodule 6062 further includes:

a minimum deliverable order quantity obtaining unit, configured to obtain a minimum deliverable order quantity corresponding to each target delivery mode from the configuration database when at least two target delivery modes are determined;

a delivery mode selection unit, configured to select a delivery mode from the at least two target delivery modes according to the minimum deliverable order quantity.

In some embodiments of the present disclosure, when an operation of submitting the order is received, the delivery mode determining submodule 6062 includes:

an information change determining unit, configured to determine whether the target location information and the order placing time of the order have changed;

a delivery mode change determining unit, configured to determine, according to the changed target location information and/or order placing time, whether to change the delivery mode, in response to that the target location information and/or order placing time of the order has changed;

a delivery mode change prompting unit, configured to prompt a change of the delivery mode to the user in response to that the delivery mode has changed.

In some embodiments of the present disclosure, the delivery mode change determining unit includes:

a first delivery mode change subunit, configured to determine a target delivery mode among at least one delivery mode according to the original order placing time, the changed target location information, the merchant location information, and the effective time and the effective range that correspond to the delivery mode in response to that the target location information of the order has changed;

a second delivery mode change subunit, configured to determine a target delivery mode among at least one delivery mode according to the changed order placing time, the original target location information, the merchant location information, and the effective time and the effective range that correspond to the delivery mode in response to that the order placing time of the order has changed; and

a third delivery mode change subunit, configured to determine a target delivery mode among at least one delivery mode according to the changed order placing time, the changed target location information, the merchant location information, and the effective time and the effective range that correspond to the delivery mode in response to that the target location information and the order placing time of the order have changed.

In some embodiments of the present disclosure, the first deliverer notification submodule 6063 further includes:

an after-change notification unit, configured to send order-taking notification information to the deliverer corresponding to the changed delivery mode in response to receiving an operation of confirming the change of the delivery mode; and

a before-change notification unit, configured to send order-taking notification information to a deliverer corresponding to a before-change delivery mode in response to receiving an operation of ignoring the change of the delivery mode;

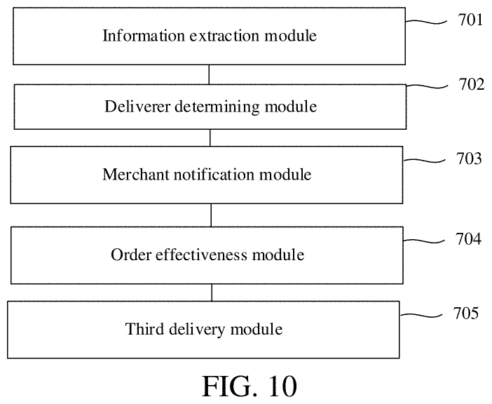

Refer to FIG. 10, which shows a structural diagram of an order delivery processing apparatus according to an embodiment of the present disclosure, as detailed below:

an information extraction module 701, configured to extract target location information and merchant location information from an order when the received order meets a preset delivery condition;

a deliverer determining module 702, configured to determine a target deliverer set according to the target location information and the merchant location information, and display the order to deliverers in the target deliverer set;

a merchant notification module 703, configured to send order-taking notification information to a merchant in response to receiving an order-taking operation of a deliverer in the target deliverer set;

an order effectiveness module 704, configured to determine an effective state of the order in response to receiving an order-taking operation fed back by the merchant in response to the order-taking notification information; and a third delivery module 705, configured to deliver the effective order.

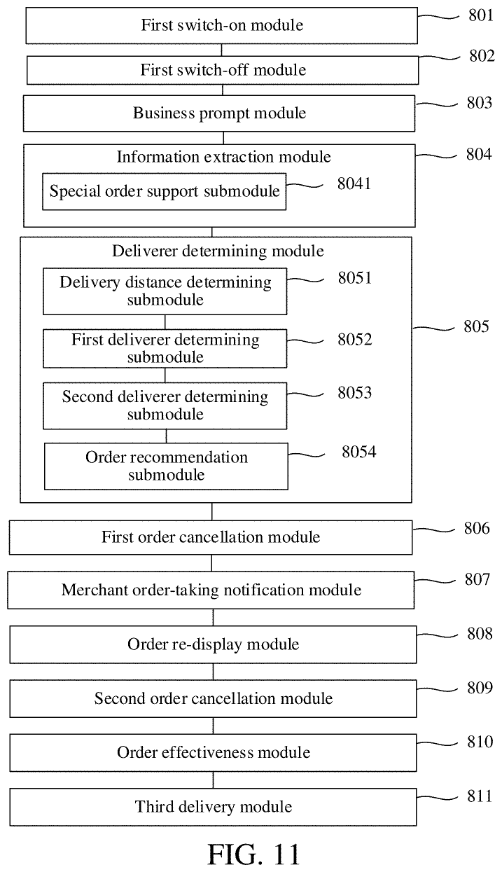

Refer to FIG. 11, which shows a structural diagram of an order delivery processing apparatus according to an embodiment of the present disclosure, specifically including: a first switch-on module 801, a first switch-off module 802, a business prompt module 803, an information extraction module 804, a deliverer determining module 805, a first order cancellation module 806, a merchant notification module 807, an order re-displaying module 808, a second order cancellation module 809, an order effectiveness module 810, and a third delivery module 811.

The first switch-on module 801 is configured to modify a first switch corresponding to the merchant in the configuration database to an on state in response to detecting a merchant's instruction of activating support of orders of a target type.

The first switch-off module 802 is configured to modify a first switch corresponding to the merchant in the configuration database to an off state in response to detecting a merchant's instruction of canceling support of orders of a target type.

The business prompt module 803 is configured to send a prompt to the user in response to receiving an operation of searching for the merchant, where the prompt indicates whether each target merchant searched out supports the orders of the target type.

The information extraction module 804 is configured to extract target location information and merchant location information from an order when the received order meets a preset delivery condition. In some embodiments of the present disclosure, the information extraction module 804 includes:

a special order support submodule 8041, configured to deliver the orders of the target type based on a first preset rule when the merchant corresponding to the received order supports the orders of the target type.

The deliverer determining module 805 is configured to determine a target deliverer set according to the target location information and the merchant location information, and display the order to deliverers in the target deliverer set. In some embodiments of the present disclosure, the deliverer determining module 805 includes:

a delivery distance determining submodule 8051, configured to determine a delivery distance according to the target location information and the merchant location information;

a first deliverer determining submodule 8052, configured to determine, when the delivery distance is greater than or equal to the preset first distance threshold, a deliverer whose score is greater than or equal to a preset score threshold in the first deliverer set, so as to obtain a target deliverer set;

a second deliverer determining submodule 8053, configured to use the first deliverer set as the target deliverer set when no order-taking operation is received within the first preset time segment; and an order recommendation submodule 8054, configured to recommend, when the delivery distance is greater than or equal to a preset second distance threshold, the order to a deliverer who is in the first deliverer set and near the merchant, where the second distance threshold is less than the first distance threshold.

The first order cancellation module 806 is configured to cancel the order when no order-taking operation of the deliverer is received within a third preset time segment.

The merchant notification module 807 is configured to send order-taking notification information to a merchant in response to receiving an order-taking operation of a deliverer in the target deliverer set.

The order re-display module 808 is configured to re-display the order to the deliverers in the target deliverer set in response to receiving a cancellation operation on the order from the deliverer.

The second order cancellation module 809 is configured to cancel the order when no order-taking operation of the merchant is received within a second preset time segment.

The order effectiveness module 810 is configured to determine an effective state of the order in response to receiving an order-taking operation fed back by the merchant in response to the order-taking notification information.

The third delivery module 811 is configured to deliver the effective order.

The plurality of embodiments of the present disclosure further provide an electronic device. The electronic device includes a processor, a memory, and a computer program stored in the memory and run on the processor, and the processor implements the order delivery processing method according to any one of the foregoing embodiments when executing the program.

An embodiment of the present disclosure further provides a readable storage medium. Instructions in the storage medium, when being executed by a processor of an electronic device, cause the electronic device to perform the order delivery processing method according to any one of the foregoing embodiments.

The apparatus embodiments are substantially similar to the method embodiments and therefore are only briefly described, and reference may be made to the method embodiments for the corresponding sections.

Algorithms and displaying provided herein are not inherently related to a particular computer, a virtual system, or another device. Various general purpose systems may also be used together with teachings herein. In accordance with the foregoing descriptions, a structure required for constructing such system is obvious. In addition, the present disclosure is not specific to any particular programming language. It should be understood that the content in the present disclosure described herein may be implemented by using various programming languages, and the foregoing description of the particular language is intended to disclose exemplary embodiments of the present disclosure.

Lots of specific details are described in the specification provided herein. However, it will be appreciated that the embodiments of the present disclosure may be implemented in a case without these specific details. In some examples, known methods, structures, and technologies are not disclosed in detail, so as not to mix up understanding on the specification.

Similarly, it should be appreciated that to simplify the present disclosure and help to understand one or more of the disclosed aspects, in the foregoing descriptions of the exemplary embodiments of the present disclosure, features of the present disclosure are sometimes grouped into a single embodiment or figure, or descriptions thereof. However, the methods in the present disclosure should not be construed as reflecting the following intention: that is, the present disclosure claimed to be protected is required to have more features than those clearly set forth in each claim. Or rather, as reflected in the following claims, the disclosed aspects aim to be fewer than all features of a single embodiment disclosed above. Therefore, the claims complying with a specific implementation are definitely combined into the specific implementation, and each claim is used as a single embodiment of the present disclosure.

Those persons skilled in the art may understand that modules in the device in the embodiments may be adaptively changed and disposed in one or more devices different from that in the embodiments. Modules, units, or components in the embodiments may be combined into one module, unit, or component, and moreover, may be divided into a plurality of sub-modules, subunits, or subcomponents. Unless at least some of such features and/or processes or units are mutually exclusive, all features disclosed in this specification (including the accompanying claims, abstract, and drawings) and all processes or units in any disclosed method or device may be combined by using any combination. Unless otherwise definitely stated, each feature disclosed in this specification (including the accompanying claims, abstract, and drawings) may be replaced with a replacement feature providing a same, an equivalent, or a similar objective.

The component embodiments of the present disclosure may be implemented by using hardware, may be implemented by using software modules running on one or more processors, or may be implemented by using a combination thereof. A person skilled in the art should understand that some or all functions of some or all components according to the order delivery processing apparatus of the embodiments of the present disclosure may be implemented by using a microprocessor or a digital signal processor (DSP) in practice. The present disclosure may further be implemented as a device or device program configured to perform some or all of the methods described herein. Such program for implementing the present disclosure may be stored on a computer-readable medium, or may have one or more signal forms. Such signal may be obtained through downloading from an Internet website, may be provided from a carrier signal, or may be provided in any other forms.

It should be noted that the foregoing embodiments are descriptions of the present disclosure instead of a limitation on the present disclosure, and a person skilled in the art may design a replacement embodiment without departing from the scope of the accompanying claims. In the claims, any reference symbol located between brackets should not constitute a limitation on the claims. The word “comprise” does not exclude an element or a step not listed in the claims. The word “a” or “one” located previous to an element does not exclude existence of a plurality of such elements. Embodiments of the present disclosure may be implemented by hardware including several different elements and an appropriately programmed computer. In the unit claims listing several devices, some of the devices may be specifically presented by using the same hardware. Use of the words such as “first”, “second”, and “third” does not indicate any sequence. These words may be construed as names.

A person skilled in the art may clearly understand that, for simple and clear description, for specific work processes of the foregoing described system, apparatus, and unit, reference may be made to corresponding process in the foregoing method embodiments, and details are not described herein again.

The foregoing descriptions are merely exemplary embodiments of the present disclosure, but are not intended to limit the present disclosure. Any modification, equivalent replacement, improvement, or the like made within the spirit and principle of the present disclosure shall fall within the protection scope of the present disclosure.

The foregoing descriptions are merely specific embodiments of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

1. An order delivery processing method, comprising:
extracting target location information and merchant location information from a received order;
determining, according to the target location information and the merchant location information, whether the order is in a preset delivery range;
delivering the order based on a first preset rule when the order is not in the preset delivery range, wherein the delivering the order based on a first preset rule comprises:
determining a target deliverer set according to the target location information and the merchant location information;
displaying the order to deliverers in the target deliverer set;
sending first order-taking notification information to a merchant in response to receiving an order-taking operation of a deliverer in the target deliverer set; and
determining that the order is effective in response to receiving an order-taking operation fed back by the merchant in response to the first order-taking notification information; and
delivering the order based on a second preset rule when the order is in the preset delivery range.

2. The method according to claim 1, wherein the delivering the order based on a second preset rule comprises:
sending second order-taking notification information to the merchant;
determining a target delivery mode of the order among preset delivery modes according to the target location information and the merchant location information in response to receiving an order-taking operation fed back by the merchant in response to the second order-taking notification information;
sending the second order-taking notification information to a deliverer corresponding to the target delivery mode; and
determining that the order is effective in response to receiving an order-taking operation fed back by the deliverer corresponding to the target delivery mode in response to the second order-taking notification information.

3. The method according to claim 2, wherein the determining a target delivery mode of the order among preset delivery modes according to the target location information and the merchant location information comprises:
extracting an order placing time from the order;
obtaining, from a preset configuration database, at least one delivery mode corresponding to the merchant and an effective time and an effective range that correspond to each delivery mode; and
determining the target delivery mode among the at least one delivery mode according to the order placing time, the target location information, the merchant location information, and the effective time and the effective range that correspond to each delivery mode.

4. The method according to claim 3, further comprising:
receiving the merchant's operation of setting a delivery mode, a corresponding effective time and effective range, and a deliverable order minimum fee; and
binding and saving the delivery mode, the corresponding effective time and effective range, and the minimum deliverable order quantity into the configuration database.

5. The method according to claim 3, further comprising:
obtaining a deliverable order minimum fee corresponding to each target delivery mode from the configuration database when at least two target delivery modes are determined; and
selecting a final delivery mode from the at least two target delivery modes according to the deliverable order minimum fee.

6. The method according to claim 1, further comprising:
determining, in response to an operation of submitting the order, whether the target location information and the order placing time of the order have changed; and
re-determining a delivery mode based on the changed target location information and/or order placing time in response to that the target location information and/or the order placing time of the order has changed.

7. The method according to claim 1, wherein the extracting target location information and merchant location information from a received order comprises:
determining whether the order meets a preset delivery condition; and
extracting the target location information and the merchant location information from the order when the order meets the preset delivery condition.

8. The method according to claim 1, wherein the determining a target deliverer set according to the target location information and the merchant location information comprises:
determining a delivery distance according to the target location information and the merchant location information; and
determining, when the delivery distance is greater than or equal to a preset first distance threshold, a deliverer whose score is greater than or equal to a preset score threshold in a first deliverer set, so as to obtain the target deliverer set.

9. The method according to claim 8, wherein the determining a target deliverer set according to the target location information and the merchant location information further comprises:
using the first deliverer set as the target deliverer set when no order-taking operation is received from any deliverer in the target deliverer set within a first preset time segment.

10. The method according to claim 8, wherein the determining a target deliverer set according to the target location information and the merchant location information further comprises:
determining, when the delivery distance is less than the first distance threshold and greater than or equal to a preset second distance threshold, a deliverer located away from the merchant at a distance less than a third distance threshold in the first deliverer set, so as to obtain the target deliverer set.

11. The method according to claim 7, wherein the determining whether the order meets a preset delivery condition comprises:
determining, when the merchant corresponding to the order supports orders of a target type, that the order meets the preset delivery condition, wherein the orders of the target type are delivered based on the first preset rule.

12. The method according to claim 11, further comprising:
modifying a first switch corresponding to the merchant in the configuration database to an on state in response to detecting a merchant's instruction of activating support of the orders of a target type; and
modifying the first switch corresponding to the merchant in the configuration database to an off state in response to detecting a merchant's instruction of canceling support of the orders of a target type.

13. The method according to claim 11, further comprising:
sending, in response to receiving a user's operation of searching for the merchant, a prompt to the user to indicate whether the merchant supports the orders of the target type.

14. The method according to claim 7, wherein after sending the first order-taking notification information to the merchant, the method further comprises:
re-displaying the order to the deliverers in the target deliverer set in response to receiving a cancellation operation on the order from the deliverer.

15. The method according to claim 1, wherein after sending the first order-taking notification information to the merchant, the method further comprises:
canceling the order when no order-taking operation fed back by the merchant in response to the first order-taking notification information is received within a second preset time segment.

16. The method according to claim 1, wherein after displaying the order to the deliverers in the target deliverer set, the method further comprises:
canceling the order when no order-taking operation is received from any deliverer in the target deliverer set within a third preset time segment.

17. (canceled)

18. An electronic device, comprising:
a processor; and
a memory, configured to store a computer program;
wherein the processor, when executing the computer program, is configured to:
extract target location information and merchant location information from a received order;
determine, according to the target location information and the merchant location information, whether the order is in a preset delivery range;
deliver the order based on a first preset rule when the order is not in the preset delivery range, wherein the deliver the order based on a first preset rule comprises:
determining a target deliverer set according to the target location information and the merchant location information;
displaying the order to deliverers in the target deliverer set;
sending first order-taking notification information to a merchant in response to receiving an order-taking operation of a deliverer in the target deliverer set; and
determining that the order is effective in response to receiving an order-taking operation fed back by the merchant in response to the first order-taking notification information; and
deliver the order based on a second preset rule when the order is in the preset delivery range.

19. A readable storage medium, wherein when an instruction in the storage medium is executed by a processor of an electronic device, the electronic device is enabled to perform the following steps:
extracting target location information and merchant location information from a received order;
determining, according to the target location information and the merchant location information, whether the order is in a preset delivery range;
delivering the order based on a first preset rule when the order is not in the preset delivery range, wherein the delivering the order based on a first preset rule comprises:
determining a target deliverer set according to the target location information and the merchant location information;
displaying the order to deliverers in the target deliverer set;
sending first order-taking notification information to a merchant in response to receiving an order-taking operation of a deliverer in the target deliverer set; and
determining that the order is effective in response to receiving an order-taking operation fed back by the merchant in response to the first order-taking notification information; and
delivering the order based on a second preset rule when the order is in the preset delivery range.

20. The electronic device according to claim 18, wherein the delivering the order based on a second preset rule comprises:
sending second order-taking notification information to the merchant;
determining a target delivery mode of the order among preset delivery modes according to the target location information and the merchant location information in response to receiving an order-taking operation fed back by the merchant in response to the second order-taking notification information;
sending the second order-taking notification information to a deliverer corresponding to the target delivery mode; and
determining that the order is effective in response to receiving an order-taking operation fed back by the deliverer corresponding to the target delivery mode in response to the second order-taking notification information.

21. The readable storage medium according to claim 19, wherein the delivering the order based on a second preset rule comprises:
sending second order-taking notification information to the merchant;
determining a target delivery mode of the order among preset delivery modes according to the target location information and the merchant location information in response to receiving an order-taking operation fed back by the merchant in response to the second order-taking notification information;
sending the second order-taking notification information to a deliverer corresponding to the target delivery mode; and
determining that the order is effective in response to receiving an order-taking operation fed back by the deliverer corresponding to the target delivery mode in response to the second order-taking notification information.
